(19) United States
(12) Patent Application Publication
(10) Pub. No.: US 2009/0093894 A1
(43) Pub. Date: Apr. 9, 2009

(54) Production management system and method of controlling the same

(75) Inventor: Jong Shik Shin, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/216,708

(22) Filed: Jul. 9, 2008

(30) Foreign Application Priority Data
Oct. 4, 2007 (KR) 10-2007-0099737

(51) Int. Cl. G05B 19/02

(52) U.S. Cl. 700/86

(57) ABSTRACT

A system for managing an Ethernet/IP-based network production system and a control method thereof are disclosed. A production management system, minimizes the loss and negative influences caused by interrupted conventional installations when a new installation is added to the network production system, so that the production management system maximizes the efficiency of production installations. The production management system includes a conventional installation having tag information registered therein, and a control installation additionally registering tag information of a new installation in the conventional installation after the new installation has been added.

### CROSS-REFERENCE TO RELATED APPLICATIONS

This application claims the benefit of Korean Patent Application No. 2007-0099737, filed on Oct. 4, 2007 in the Korean Intellectual Property Office, the disclosure of which is incorporated herein by reference.

### BACKGROUND

1. Field

The present invention relates to an apparatus to manage production systems connected to a network and a method of controlling the same, and more particularly to a production management system and a control method thereof, which minimize the loss of an overall production system and stably add a new installation, after the new installation has been added during a driving time of a network production system.

2. Description of the Related Art

Generally, an Ethernet is the most widely-installed Local Area Network (LAN) technology. Initially, the Ethernet is designed on a bus topology, so that all stations can access the bus and can transmit data at all times. Thereafter, the Ethernet technology has been more conveniently developed via a star topology and a hub, so that it has been upgraded to the industrial Ethernet capable of measuring and controlling in real time. The Ethernet is combined with the TCP/IP (Transmission Control Protocol/Internet Protocol) commonly used, the reliability (characterization) for control in an industrial field and the operating possibility under the industrial environment are satisfied.

In the meantime, the Ethernet/IP (Industrial Protocol) is the most developed industrial Ethernet network solution available for factory automation, and defines an open industrial standard based on extended traditional Ethernet. The Ethernet/IP is based on the TCP/IP-protocol series, and selects the lower 4-layers of the OSI-layer model. A variety of general Ethernet-communication modules, for example, a PC interface card, a cable, a connector, a hub, and a switch, for example, have been used along with the Ethernet/IP.

The Ethernet/IP is one part of a network which executes a Common Industrial Protocol (CIP) contained in an upper layer, and provides users with media independent protocols supported by several hundreds of vendors throughout the world. This protocol provides users with integrated messages and services for a variety of factory automation applications including control-, safety-, synchronization-, motion-, and configuration-information. The user can select the CIP network which is the most appropriate for each application. One of the options is the Ethernet/IP, and the Ethernet/IP is created by applying the CIP to the Ethernet technology.

Conventionally, as shown in FIG. 1, if a network production system 10 composed of the Ethernet/IP desires to add a new installation 12 to increase a production yield or to change a production method, all the conventional installations 11 stop operation, and the new installation 12 is connected to the conventional installations 11 by hardware.

Then, tag information related to communication of the new installation 12 is registered in the conventional installations 11, and the new installation 12 is connected to the network, so that the new installation 12 is driven.

However, if the conventional network production system desires to add the new installation, all the conventional installations stop operation, so that there arises an enormous loss from the installations being interrupted for a long time. The conventional network production system is affected by the new installation, so that all installations are unavoidably shut down.

### SUMMARY

Therefore, it is an aspect of the embodiment to provide a production management system which minimizes the loss of an overall production system and stably adds a new installation during a driving time of the network production system, and a method of controlling the production management system.

Additional aspects and/or advantages of the invention will be set forth in part in the description which follows and, in part, will be obvious from the description, or may be learned by practice of the invention.

In accordance with the invention, the above and/or other aspects can be achieved by the provision of a production management system, including: at least one conventional installation having tag information registered therein; and a control installation additionally registering tag information of a new installation in the conventional installation after the new installation has been added.

The control installation, may receive the tag information from the new installation and additionally register the tag information in one of the at least one conventional installations corresponding to the tag information when a number of conventional installations is at least two.

The control installation may include: a receiver receiving the tag information from the new installation; a storage unit storing an overall tag list; and a controller comparing the tag information with the overall tag list, verifying a validity of the tag information, and additionally registering the tag information in the at least one conventional installation after the validity of the tag information has been verified.

The control installation may further include: a transmitter transmitting the tag information to the conventional installation corresponding to the tag information after the validity of the tag information has been verified.

The at least one conventional installation may receive the tag information from the control installation, re-verify the validity of the tag information, and additionally register the new installation after re-verifying the validity of the tag information.

The tag information may include at least one of a tag name, target tag information, consumer tag or producer tag information, a request packet interval (RPI), a maximum number of connections, and a data size.

The foregoing and/or other aspects are achieved by providing a method of controlling a production management system, including: receiving tag information for new registration from a new installation of the production management system after the new installation is added; and additionally registering tag information of the new installation in at least one conventional installation of the production management system.

The additional registering of the tag information of the new installation in the at least one conventional installation may include: additionally registering the tag information in a conventional installation corresponding to the tag information when a number of conventional installations is at least two.

The method may further include: verifying a validity of the tag information; transmitting the tag information to the at least one conventional installation and re-verifying the validity of the tag information when the validity of the tag information has been verified; and additionally registering the tag information in the at least one conventional installation when the validity of the tag information has been re-verified.

The verifying of the validity of the tag information may include: comparing the tag information with an overall tag list; and verifying the validity of the tag information according to the result of the comparison.

The tag information may include at least one of a tag name, target tag information, consumer tag or producer tag information, a request packet interval (RPI), a maximum number of connections, and a data size.

The foregoing and/or other aspects are achieved by providing a method of controlling a production management system, including: receiving tag information for new registration from a new installation of the production management system; verifying a validity of the tag information; and transmitting the tag information to a conventional installation of the production management system after the validity of the tag information has been verified.

The foregoing and/or other aspects are achieved by providing a method of controlling a production management system, including: receiving verified tag information of a new installation from a control installation of the production management system; reverifying the verified tag information; and registering the new installation when the verified tag information has been reverified.

The foregoing and/or other aspects are achieved by providing a method of controlling a production management system, including: transmitting tag information for new registration in the production management system to a control installation of the production management system; and receiving an indication that additional registration of the tag information is completed after the tag information has been verified by the control installation and has been reverified by at least one conventional installation of the production management system.

### BRIEF DESCRIPTION OF THE DRAWINGS

These and/or other aspects and advantages will become apparent and more readily appreciated from the following description of the embodiment, taken in conjunction with the accompanying drawings of which:

FIG. 1 is a conceptual diagram illustrating a method of adding a new installation to a conventional network production system;

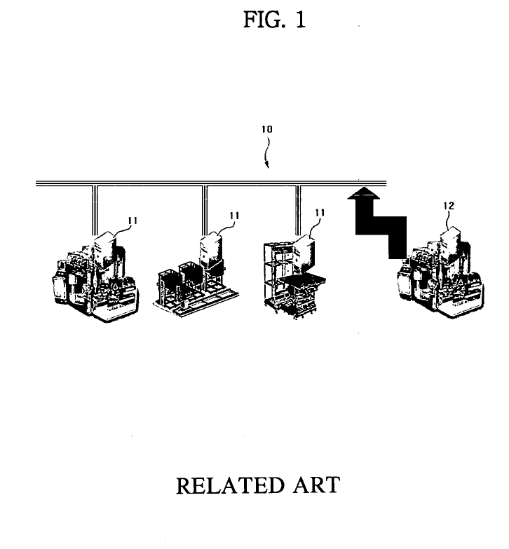

FIG. 2 is a block diagram illustrating a production management system according to the present embodiment;

FIG. 3 is a structural diagram illustrating tag information received from a receiver of FIG. 2 according to the present embodiment; and

FIG. 4 is a flow chart illustrating a method of controlling the production management system according to the present embodiment.

### DETAILED DESCRIPTION OF EMBODIMENT

Reference will now be made in detail to the embodiment, examples of which are illustrated in the accompanying drawings, wherein like reference numerals refer to like elements throughout. The embodiment is described below to explain the present invention by referring to the figures.

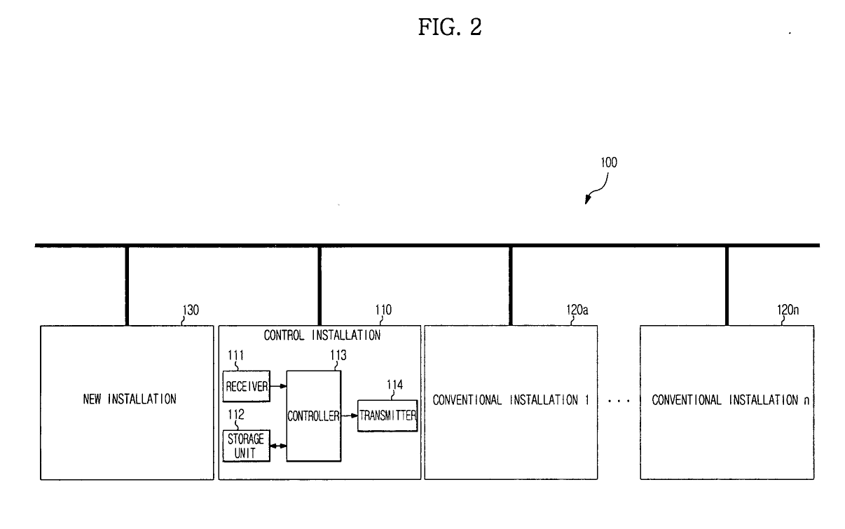

FIG. 2 is a block diagram illustrating a production management system according to the present embodiment.

Referring to FIG. 2, the production management system 100 according to the present embodiment includes a control installation 110, a conventional installation 120, and a new installation 130 to be newly added.

First, the control installation 110 assumes that a tag manager serving as an application program for a management system is installed. The new installation 130 can be added to the conventional production system using the tag manager. In this case, the term “tag” is communication-associated information registered in each installation. In order to allow one installation to transmit/receive data to/from another installation, tag information must be communicated between the installations at a time earlier than that of the data communication, so that the two installations must confirm their tag information.

After the new installation 130 is installed in the production system by hardware, the control installation 110 automatically registers a tag or variable without downloading the tag or variable, so that the new installation 130 can communicate with the production system 100 using a tag manager. In this case, the tag or variable may be a predetermined value for mutual communication between the new installation 130 and the production system 100, or may be prescribed in a manual for the mutual communication between them.

The control installation 110 may be conventional installations 120a-120n contained in the production system 100, or may also be a management installation additionally installed in the production system 100.

In more detail, the control installation 110 includes a receiver 111, a storage unit 112, a controller 113, and a transmitter 114.

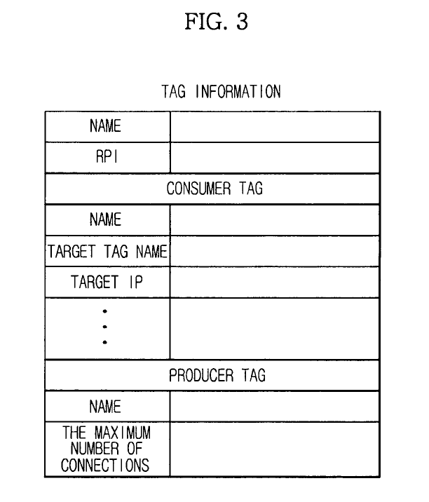

As shown in FIG. 3, the receiver 111 receives tag information from the new installation 130.

The tag information may include at least one of a tag name, target tag information, consumer tag or producer tag information, a request packet interval (RPI), a maximum number of connections, and a data size, for example.

In this case, the consumer tag is used to transmit a request signal prior to data communication. The producer tag is used to receive the request signal of the consumer tag. The target tag receives the request signal from the consumer tag. The RPI indicates a request signal or a data transfer rate. The maximum number of connections at the consumer tag is the maximum number of producer tags connected to the consumer tag. The maximum number of connections at the producer tag is the maximum number of consumer tags connected to the producer tag.

The storage unit 112 stores an overall tag list.

In other words, the storage unit 112 stores information of all conventional installations 120a-120n connected to the current production system 100 and individual tag lists of the conventional installations 120a-120n.

The controller 113 compares tag information with the total tag list, and verifies a validity of tag information.

In other words, the controller 113 compares tag information with the total tag list, and determines whether tag information of the new installation 130 to be added to the production system is appropriate or not according to the comparison result.

In more detail, the controller 113 determines whether the tag name was duplicated, determines the presence or absence of a target tag in the tag information, determines whether an IP address of the target tag was matched, determines whether a TCP port setup was correct, and verifies the validity of each tag according to the determined result. The controller 113 verifies the validity of the tag according individual tag types.

The above-mentioned verification of the tag validity will hereinafter be described. In the case of the consumer tag, the controller 113 searches for a specific installation having a target tag's IP address in the conventional production system, determines the presence or absence of a producer tag equal to a target tag of each tag, or determines whether a name of the producer tag is matched or not.

The controller 113 recognizes the maximum number of connections of the producer tag connected to the consumer tag, and determines whether the producer tag stored in each installation must be changed on the basis of the recognized maximum connections.

The controller 113 determines an Actual Packet Interval (API) using the RPI indicating a data transfer rate of each tag, compares the API with the RPI of the new installation 130's tag, and verifies the validity.

In the case of the producer tag, the controller 113 verifies the validity on the basis of the number of installations contained in a current production system, the number of associated installations, and the maximum number of connections.

If the validity of the tag information has been verified, the transmitter 114 transmits tag information to the conventional installations 120a-120n corresponding to tag information.

If the transmitter 114 receives tag additional registration completion signals “Reg” from the conventional installations 120a-120n via the receiver 111, the transmitter 114 transmits a broadcasting signal to the installations of all production systems to indicate that additional registration of new tag information has been completed.

In the meantime, the conventional installations 120a-120n receive tag information from the control installation 110, and re-verify the validity of the received tag information.

In other words, the conventional installations 120a-120n receive tag information related to themselves, and re-verify the validity of the received tag information. If the re-verifying is completed, tag information of the new installation 130 is additionally registered in the conventional installations 120a-120n, so that the control installation 110 can recognize that additional registration of new tag information has been completed.

A method of controlling the production management system according to the present embodiment will hereinafter be described.

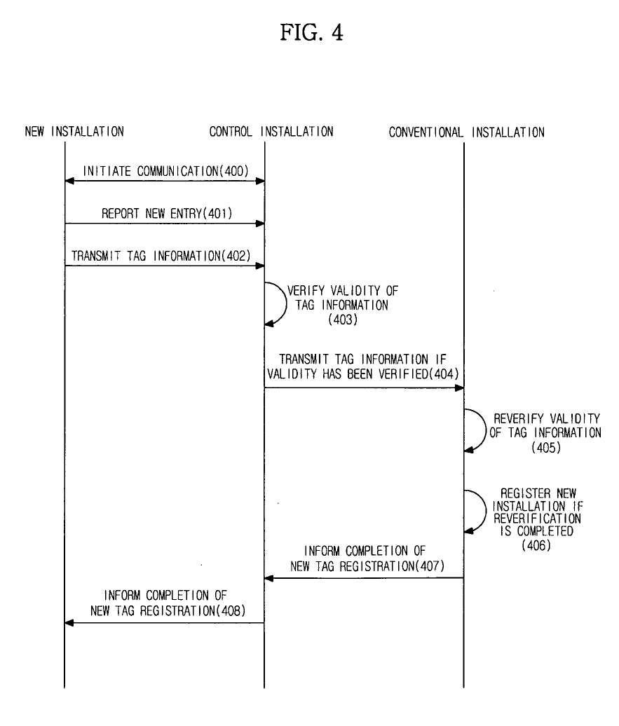

FIG. 4 is a flow chart illustrating a method of controlling the production management system according to the present embodiment. Referring to FIG. 4, the control installation 110 communicates with the new installation 130 using a 3-way handshake scheme at operation 400.

In this case, the 3-way handshake scheme is used to initialize a TCP connection, and guarantees that the control installation 110 and the new installation 130 are ready to transmit data. In fact, prior to the beginning of data transmission, one installation is ready to transmit data to the other installation.

Then, the new installation 130 informs the control installation 110 of the new entry at operation 401. In other words, the new installation 130 transmits a signal of the new entry report to the control installation 110, so that the new installation 130 informs the control installation 110 of the new entry.

After the new installation 130 reports the new entry, the new installation 130 transmits tag information to the control installation 110 at operation 402. The control installation 110 receives the tag information, and verifies the validity of the tag information at operation 403.

Namely, the control installation 110 compares tag information received from the new installation 130 with the pre-stored tag list, determines the presence or absence of a target installation, determines whether the target installation is matched with an IP address, or determines whether an associated TCP port setup is correct or not.

Basically, the control installation 110 determines whether a tag name is duplicated, and verifies the validity of the tag according to individual types.

As described above, if the validity is verified by the control installation 110, the control installation 110 transmits tag information to the conventional installations 120a-120n corresponding to the tag information at operation 404, so that the conventional installations 120a-120n re-verify the validity of the tag information at operation 405.

The conventional installations 120a-120n receive tag information associated with the conventional installations 120a-120n themselves, re-verify the received tag information, and complete additional registration of the new installation 130.

In other words, the conventional installations 120a-120n receive their tag information, re-verify the tag information verified by the control installation 110, determine whether the producer tag stored in tag information overlaps with producer tag names of the conventional installations 120a-120n, checks an IP address of the consumer tag stored in the tag information, and determines whether the checked consumer tag overlaps with the producer tag.

If the re-verification is completed according to the above-mentioned operations, additional registration of the tag information is executed at operation 406 after an ACK code is transmitted to the control installation 110.

In order to additionally register tag information, in the case of the producer tag, the present embodiment determines whether the producer tag name is duplicated or not. If a new name is duplicated, the value of 1 is added to the maximum number of connections. If the new name is not duplicated, tag information is registered as a new tag.

If new tag information is completely registered, the conventional installations (120a-120n) transmit the “Reg” completion signal indicating registration completion of new tag information to the control installation 110 at operation 407, and the control installation 110 informs the new installation 130 that additional registration of new tag information is completed at operation 408. In other words, a signal indicating additional registration of new tag information is completed is transmitted to installations connected to all production systems 100.

Individual installations receiving the aforementioned signal are driven by the new system equipped with the new installation 130.

As is apparent from the above description, according to the above-mentioned production management system and a control method thereof, if a user desires to add a new installation during a driving time of network production systems, the present embodiment can add the new installation without stopping operations of all production systems, and can minimize the loss of production systems.

Also, the new installation can stably enter the network of the conventional production system, so that the new installation can be immediately used in the production process.

Although an embodiment has been shown and described, it would be appreciated by those skilled in the art that changes may be made in this embodiment without departing from the principles and spirit of the invention, the scope of which is defined in the claims and their equivalents.

What is claimed is:

1. A production management system, comprising:
at least one conventional installation having tag information registered therein; and
a control installation additionally registering tag information of a new installation in the conventional installation after the new installation has been added.

2. The production management system according to claim 1, wherein the control installation receives the tag information from the new installation and additionally registers the tag information in one of the at least one conventional installations corresponding to the tag information when a number of conventional installations is at least two.

3. The production management system according to claim 1, wherein the control installation includes:
a receiver receiving the tag information from the new installation;
a storage unit storing an overall tag list; and
a controller comparing the tag information with the overall tag list, verifying a validity of the tag information, and additionally registering the tag information in the at least one conventional installation after the validity of the tag information has been verified.

4. The production management system according to claim 3, wherein the control installation further includes:
a transmitter transmitting the tag information to the conventional installation corresponding to the tag information after the validity of the tag information has been verified.

5. The production management system according to claim 1, wherein the at least one conventional installation receives the tag information from the control installation, re-verifies the validity of the tag information, and additionally registers the new installation after re-verifying the validity of the tag information.

6. The production management system according to claim 1, wherein the tag information includes at least one of a tag name, target tag information, consumer tag or producer tag information, a request packet interval (RPI), a maximum number of connections, and a data size.

7. A method of controlling a production management system, comprising:
receiving tag information for new registration from a new installation of the production management system after the new installation is added; and
additionally registering tag information of the new installation in at least one conventional installation of the production management system.

8. The method according to claim 7., wherein the additional registering of the tag information of the new installation in the at least one conventional installation includes:
additionally registering the tag information in a conventional installation corresponding to the tag information when a number of conventional installations is at least two.

9. The method according to claim 7, further comprising:
verifying a validity of the tag information;
transmitting the tag information to the at least one conventional installation and re-verifying the validity of the tag information when the validity of the tag information has been verified; and
additionally registering the tag information in the at least one conventional installation when the validity of the tag information has been re-verified.

10. The method according to claim 9, wherein the verifying of the validity of the tag information includes:
comparing the tag information with an overall tag list; and
verifying the validity of the tag information according to the result of the comparison.

11. The method according to claim 7, wherein the tag information includes at least one of a tag name, target tag information, consumer tag or producer tag information, a request packet interval (RPI), a maximum number of connections, and a data size.

12. A method of controlling a production management system, comprising:
receiving tag information for new registration from a new installation of the production management system;
verifying a validity of the tag information; and
transmitting the tag information to a conventional installation of the production management system after the validity of the tag information has been verified.

13. A method of controlling a production management system, comprising:
receiving verified tag information of a new installation from a control installation of the production management system;
reverifying the verified tag information; and
registering the new installation when the verified tag information has been reverified.

14. A method of controlling a production management system, comprising:
transmitting tag information for new registration in the production management system to a control installation of the production management system; and
receiving an indication that additional registration of the tag information is completed after the tag information has been verified by the control installation and has been reverified by at least one conventional installation of the production management system.
